(19) United States
(12) Patent Application Publication
(10) Pub. No.: US 2007/0002809 A1
(43) Pub. Date: Jan. 4, 2007

(54) Recovery techniques for wireless communications networks

(76) Inventors: Jukka Reunamaki, Tampere (FI); Juha Salokannel, Tampere (FI); Harald Kaaja, Jarvenpaa (FI); Ulrico Celentano, Oulu (FI); Tommy Ginman, Espoo (FI)

Correspondence Address: MORGAN & FINNEGAN, LLP, 3 World Financial Center, New York, NY, 10281-2101, US

(21) Appl. No.: 11/169,765

(22) Filed: Jun. 30, 2005

(51) Int. Cl. H04Q 7/24

(52) U.S. Cl. 370/338

(57) ABSTRACT

A device participates in a wireless communications network having a coordinator device that is responsible for allocating resources in the wireless communications network. Further, the device establishes a peer-to-peer connection with a remote device in the wireless communications network. This peer-to-peer connection is based on a reservation of resources from the coordinator device, wherein the reservation has one or more timing parameters. Upon detecting a disappearance of the coordinator device from the wireless communications network, communications with the remote device continues according to the one or more timing parameters of the peer-to-peer connection.

### FIELD OF THE INVENTION

The present invention relates to wireless communications. More particularly, the present invention relates to recovery techniques in wireless communications networks.

### BACKGROUND OF THE INVENTION

Short-range wireless communications networks typically involve devices that have a communications range of one hundred meters or less. To provide communications over long distances, these networks often interface with other networks. For example, short-range networks may interface with cellular networks, wireline telecommunications networks, and the Internet.

Terminals in short-range wireless networks often behave in an ad hoc manner. That is, they dynamically create and terminate connections with each other. For instance, a terminal may create a connection when it desires to communicate with another terminal in its communications range or coverage area.

Ad hoc networks typically employ wireless transmission techniques that are well suited for short-range communications. Examples of such techniques include Bluetooth, IEEE 802.15.3, and ultra wideband (UWB) technologies.

Various short-range networks, such as Bluetooth and IEEE 802.15.3 networks, are referred to as wireless personal area networks (WPANs) or piconets. These networks include a single coordinator device (e.g, a master or piconet coordinator) and multiple non-coordinating devices (e.g., DEVs or slave devices)

IEEE 802.15.3 specifies a WPAN having multiple devices (DEVs). One of these devices functions as a piconet coordinator (PNC) while the other devices behave in a non-coordinator role. The timing of IEEE 802.15.3 piconets are based on a repeating pattern of “superframes” in which the network devices may be allocated communications resources.

Connections between the devices within an IEEE 802.15.3 piconet may be either “normal” connections or peer-to-peer connections. In “normal” connections, all traffic is routed through the PNC, while in peer-to-peer connections, all traffic is sent directly between the peer devices (DEVs). However, peer-to-peer connections still require PNC involvement as the PNC allocates a portion of the piconet's common transmission medium for the DEVs to communicate over the peer-to-peer connection. This is because, in IEEE 802.15.3 networks, the PNC handles connection establishment for all types of connections (i.e., normal and peer-to-peer) and allocates the network's resources.

Moreover, the PNC's role is critical during the entire pendency of a connection. For instance, if a piconet's PNC loses its connection with the other DEVs in the piconet, or if the PNC needs to terminate such connections temporarily, all connections involving these DEVs are totally lost. Therefore, the PNC is a single point of failure in an IEEE 802.15.3 piconet.

Recovery of the piconet from such a failure involves recreating its connections at all levels (e.g., physical, logical, link, network, etc.). Unfortunately, this is an involved process requiring tasks, such as piconet querying and the determination of nearby DEVs. Moreover, authentication and key exchange procedures may also need to be performed for the piconet to be recovered.

Such procedures are undesirable because they require a substantial amount of valuable time. Moreover, disappearance of the PNC may cause data to be lost if the piconet cannot be reformed. Accordingly, techniques are needed for devices to maintain their communications connections when contact with a coordinator device is lost.

### SUMMARY OF THE INVENTION

The present invention provides recovery techniques for wireless communications devices. For instance, according to embodiments of the present invention, a device and method may participate in a wireless communications network having a coordinator device that is responsible for allocating resources in the wireless communications network. Further, the device and method may establish a peer-to-peer connection with a remote device in the wireless communications network. This peer-to-peer connection is based on a reservation of resources from the coordinator device, wherein the reservation has one or more timing parameters. Upon detecting a disappearance of the coordinator device from the wireless communications network, communications with the remote device continues according to the one or more timing parameters of the peer-to-peer connection.

This disappearance may be detected in various ways. For instance, this detection may involve failing to receive a beacon transmission from the coordinator device, or failing to receive a predetermined number of consecutive beacon transmission from the coordinator device.

In aspects of the present invention, a query may be sent to the remote device across the peer-to-peer connection. This query asks the remote device whether it has detected the disappearance of the coordinator device from the wireless communications network. A response to this query may indicate that the remote device continues to detect the presence of the coordinator device. Alternatively, the response may indicate that the remote device has detected the disappearance of the coordinator device.

In this case, the device and method waits for a reappearance of the coordinator device during a predetermined time interval. When the coordinator device fails to reappear during the predetermined time interval, the device and method determines with the remote device whether to become a new coordinator device for the wireless communications network.

The present invention also provides an apparatus having a transceiver and controller that are configured to perform various features of the present invention. In addition, the present invention also provides computer program product and system aspects.

Also, the present invention provides recovery techniques for networks that employ a distributed approach for the allocation of communications resources.

Embodiments of the present invention advantageously save time and prevent the loss of information. Further features and advantages of the present invention will become apparent from the following description and accompanying drawings.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The present invention will be described with reference to the accompanying drawings, wherein:

FIG. 1 is a diagram of an exemplary operational environment;

FIG. 2 is a diagram of an exemplary superframe;

FIG. 3 is a diagram of an environment in which a coordinator device has disappeared;

FIGS. 4A-4D are diagrams of various coordinator device disappearance scenarios;

FIG. 5 is a flowchart of an exemplary device operation, according to an embodiment of the present invention;

FIGS. 6A-6C are diagrams of various recovery scenarios, according to embodiments of the present invention;

FIGS. 7 and 8 are diagrams of an environment in which devices have recovered from a coordinator device disappearance, according to an embodiment of the present invention; and

FIG. 9 is a diagram of a wireless communications device, according to an embodiment of the present invention;

### DETAILED DESCRIPTION OF THE PREFERRED EMBODIMENTS

I. Operational Environment

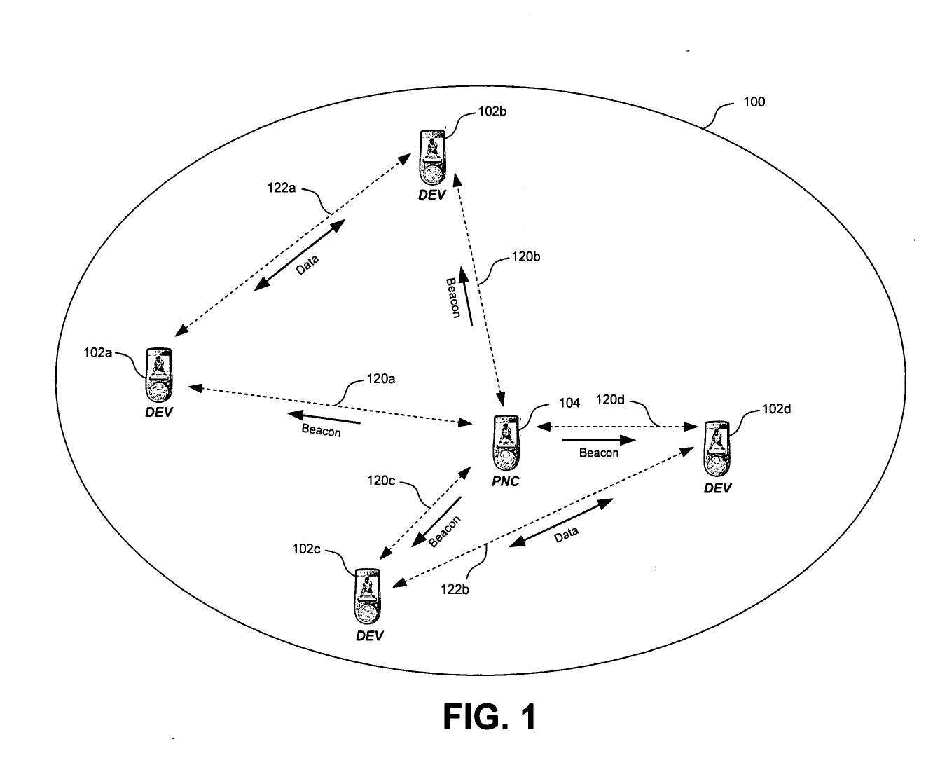

FIG. 1 is a diagram of an environment in which the present invention may be employed. In particular, FIG. 1 shows a short-range wireless communications network 100 having multiple wireless communications devices. These devices include a coordinator device 104 and multiple slave devices (DEVs) 102. Accordingly, network 100 may be an ad hoc network such as, for example, an IEEE 802.15.3 piconet or a Bluetooth network.

In network 100, each of DEVs 102 may communicate with coordinator device 104 across a corresponding link 120. For instance, FIG. 1 shows DEV 102a communicating with coordinator device 104 across a link 120a, DEV 102b communicating with coordinator device 104 across a link 120b, DEV 102c communicating with coordinator device 104 across a link 120c, and DEV 102d communicating with coordinator device 104 across a link 120d.

Each of these links 120 are referred to herein as indirect links when considering communications between DEVs 102, because they provide multihop routes for communications between DEVs 102 through coordinator device 104. As an alternative to such indirect links, DEVs 102 may communicate with each other directly. For instance, FIG. 1 shows DEVs 102a and 102b communicating across a direct link 122a (a peer-to-peer connection).

Links 120 provide for coordinator device 104 to transmit network configuration information (e.g., beacons) to DEVs 102. The network configuration information (which, in embodiments is included in beacons) may include resource allocation information, such as particular resource allocations, for various network connections according. For instance, in embodiments of the present invention, coordinator device 104 is responsible for allocating resources that establish connections across both indirect links 120 and direct links 122. In addition, coordinator device 104 may repeatedly communicate information regarding these connections through beacon transmissions.

II. Superframe

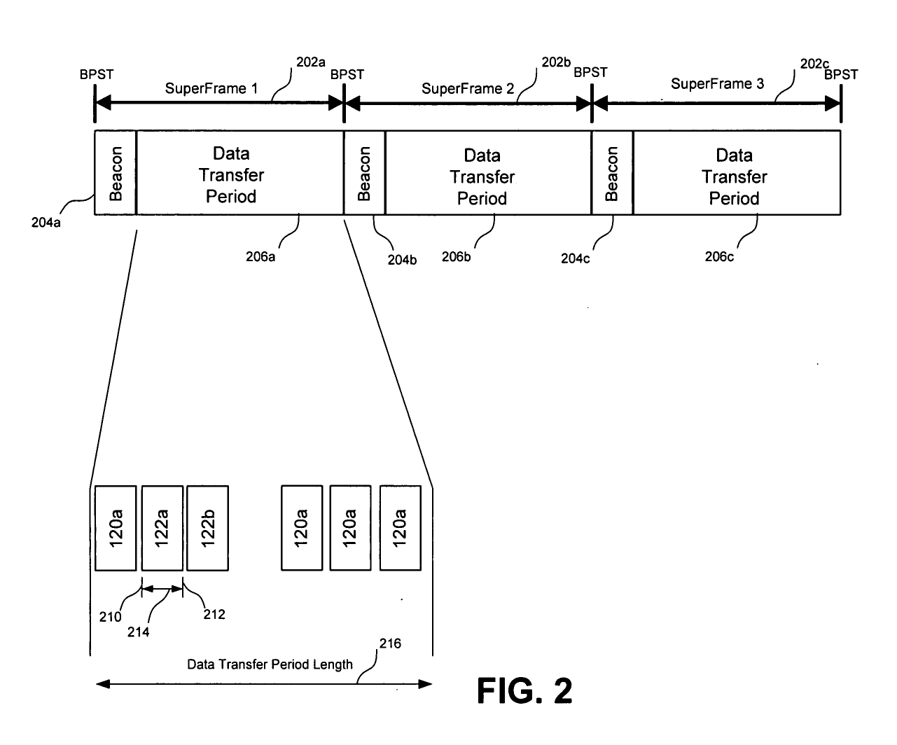

Wireless network transmissions in the environment of FIG. 1 may be based on a repeating time pattern, such as a superframe. An exemplary superframe format is shown in FIG. 2. In particular, FIG. 2 shows a frame format having superframes 202a, 202b, and 202c.

Each superframe 202 includes a beacon period 204 and a data transfer period 206. Beacon periods 204 convey network configuration information transmissions from at least the piconet coordinator device (PNC) of the beaconing group. For instance, such information may be used to set resource allocations and to communicate management information for the beaconing group. Moreover, in embodiments of the present invention, data transfer periods 206 may be used to transmit information regarding services and features (e.g., information services, applications, games, topologies, rates, security features, etc.) of devices within the beaconing group.

Data transfer period 206 is used for devices to communicate data according to various transmission schemes. These schemes may include, for example, various modulation techniques. Also, these schemes may include frequency hopping techniques. Exemplary frequency hopping techniques include orthogonal frequency division multiplexing (OFDM) and/or time frequency codes (TFCs).

Data transfer periods 206 may support data communications across links 120 and 122. For example, FIG. 2 shows an exemplary reservation of peer-to-peer links 122 within data transfer period 206. In embodiments, these allocations involve allocations provided by coordinator device 104. FIG. 2 shows that these reservations have one or more timing parameters. For example, FIG. 2 shows the reservation for link 122a having a start time 210, and end time 212, and a duration 214 within a data transfer period length 216. In addition, devices (e.g., DEVs 102a-d) may use data transfer periods 206 to transmit control information, such as request messages to other devices. To facilitate the transmission of traffic, each device may be assigned a particular time slot within each data transfer period 206.

III. Disappearance Scenarios

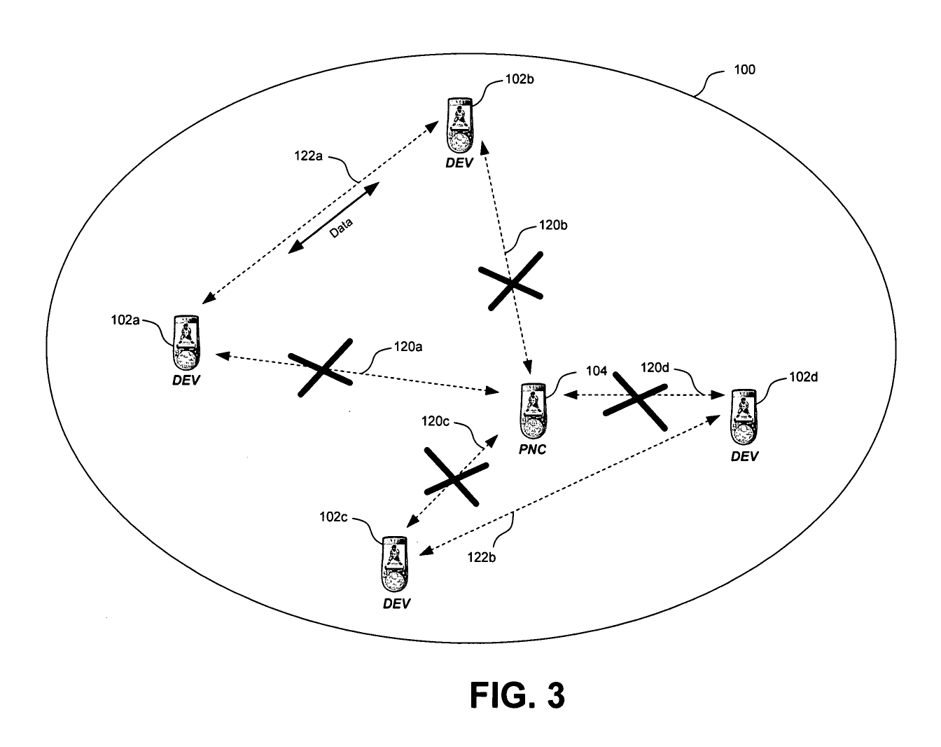

As discussed above, a coordinator device may “disappear” from an environment, such as communications network 100. FIG. 3 provides an example of such a disappearance. In particular, FIG. 3 illustrates coordinator device 104 losing its communications links with DEVs 102. This is indicated in FIG. 3 by links 120 being crossed-out. The disappearance may occur for various reasons, such as coordinator device 104 moving beyond the communications range of DEVs 102, the occurrence of interference from other systems, or the loss of power (e.g., a low battery condition) in coordinator device 104.

As a result, DEVs 102 are unable to communicate with coordinator device 104, thus precluding communications between DEVs 102 across indirect links. Moreover, DEVs 102 are unable to establish direct links with each other because there is no coordinator device to perform allocation operations for such links. However, according to embodiments of the present invention, these links may be maintained through recovery techniques in which a device for each of these links becomes a new coordinator device. This techniques are described in greater detail below.

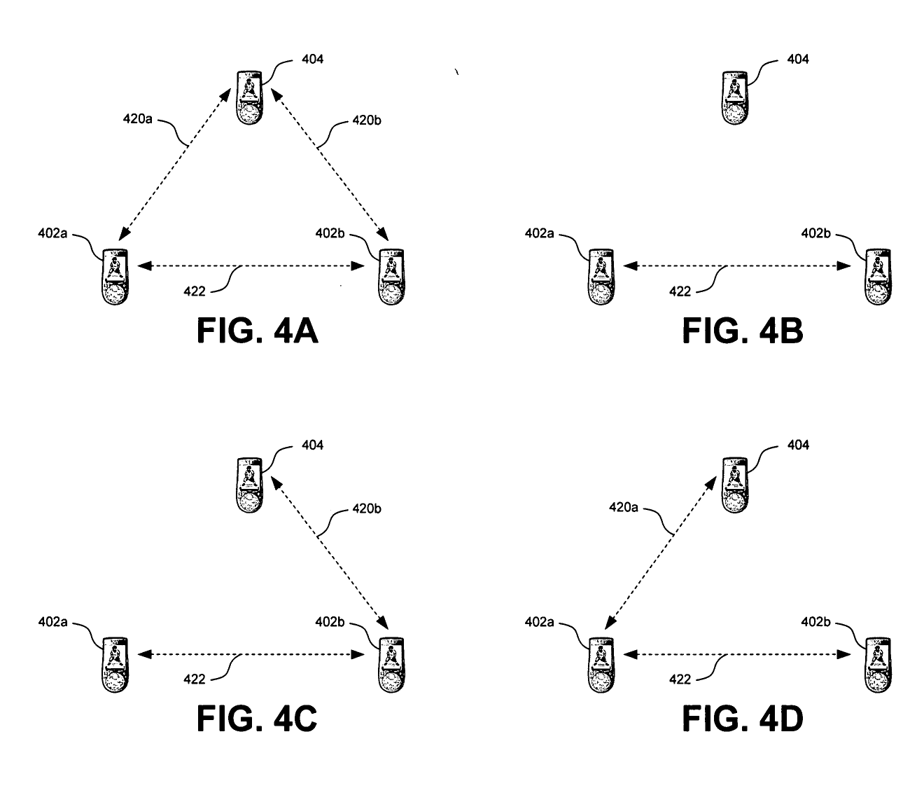

Although FIG. 3 shows a complete disappearance of coordinator device 104, various other scenarios may occur. Examples of such scenarios are shown in FIGS. 4A-4D. Each of these drawings shows a coordinator device 404 and DEVs 402a and 402b. In each of these scenarios, a direct link 422 exists between DEVs 402a and 402b.

In the scenario of FIG. 4A, coordinator device 404 is completely visible to devices 402a and 402b. Accordingly, a link 420a exists between devices 404 and 402a, and a link 420b exists between devices 404 and 402b.

In the scenario of FIG. 4B, coordinator device 404 has completely disappeared. Accordingly, links 420a and 420b no longer exist. However, link 422 between devices 402a and 402b may still exist and remain intact.

FIGS. 4C and 4D show scenarios in which coordinator device 404 has partially disappeared. More particularly, in FIG. 4C, coordinator device 404 remains visible to device 402b but is no longer visible to device 402a. However, link 422 between devices 402a and 402b may remain intact.

In contrast, FIG. 4D shows a scenario in which coordinator device 404 remains visible to device 402a, but is no longer visible to device 402b. However, link 422 between devices 402a and 402b may remain intact.

IV. Operation

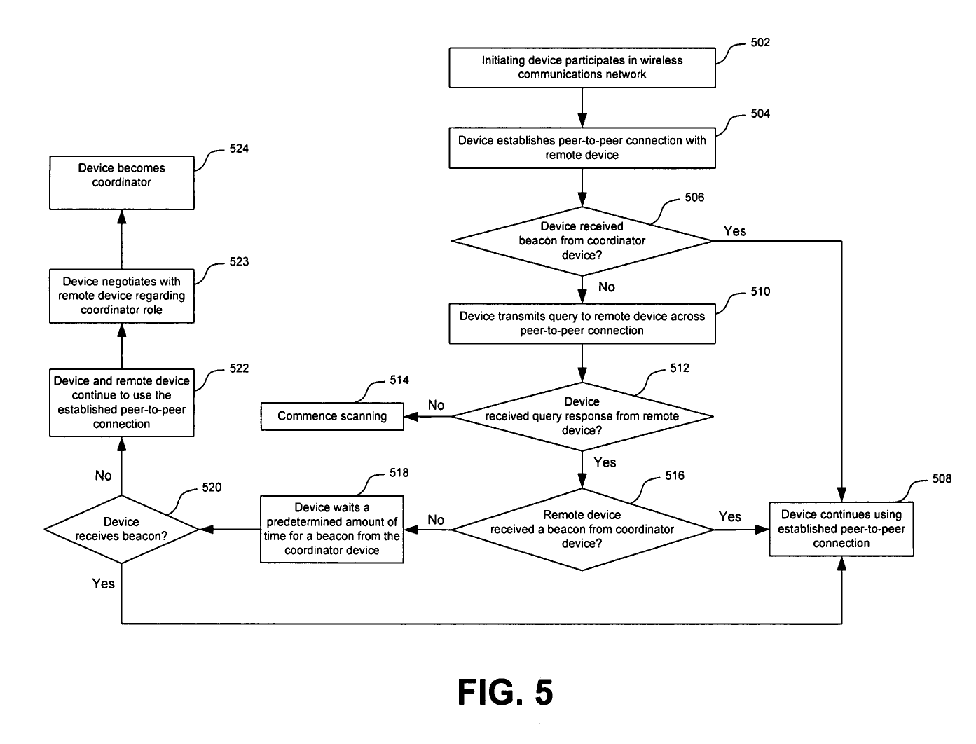

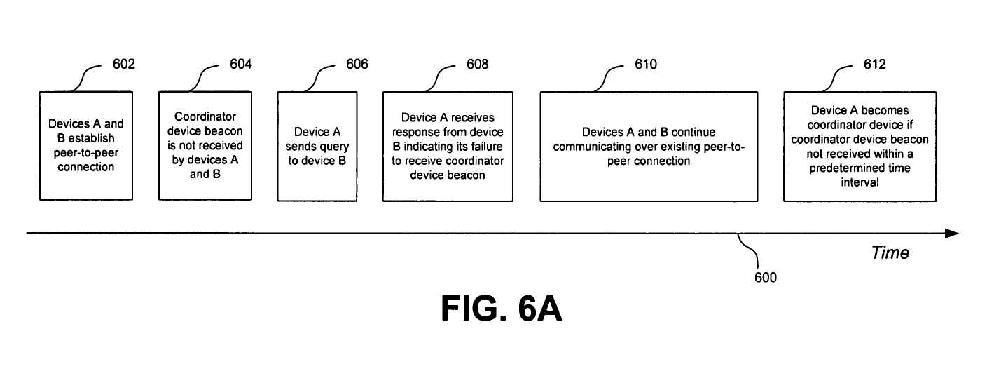

Aspects of the present invention provide techniques in which devices recover from coordinator disappearance scenarios, such as the scenarios of FIGS. 4A-4D. Accordingly, FIG. 5 is a flowchart of an exemplary device operation, according to an embodiment of the present invention. This operation provides for continued communications when a coordinator device disappears.

As shown in FIG. 5, this operation includes a step 502. In this step, a device (e.g., a slave device or DEV) participates in a short-range wireless communications network, such as an IEEE 802.15.3 piconet or a Bluetooth network. This network includes a coordinator (e.g., a PNC). Accordingly, the device may participate in the network as a slave device or DEV.

In a step 504, the device establishes a direct or peer-to-peer type of connection with a remote device. As discussed above, this connection exists across a direct link (e.g., one of links 122). Accordingly, step 504 may involve obtaining a reservation from the coordinator device. In embodiments, this reservation may be static such that it may exist so long as the participating devices desire.

This reservation has one or more timing parameters. Examples of such timing parameters may include starting time(s), ending time(s), and/or duration(s) within a timing format, such as a superframe. For instance, FIG. 2 shows a exemplary timing parameters within data transfer period 206a. In particular, FIG. 2 shows reservations for links 120 and 122 having particular timing (e.g., start times, end times, and/or durations) within the length (or duration) of data transfer period 206a.

During operation of the network, the coordinator device periodically transmits signals (or beacons) containing network status information. Thus, in a step 506, the device determines whether it has received a beacon from the coordinator device. If so, then the device continues using the allocated reservation, as indicated by a step 508. However, if the device has not received a beacon from the coordinator device, then a step 510 is performed. In embodiments, step 510 is performed when a single coordinator device beacon is not received. However, in alternate embodiments, operation proceeds from step 508 to step 510 when a predetermined number of consecutive coordinator device beacons are not received.

In step 510, the device transmits a query to the remote device across the peer-to-peer connection established in step 504. This query asks the remote device whether it has received a beacon from the coordinator device. The device may utilize a predetermined portion of the link to transmit this query. For instance, this query may be transmitted during the initial portion of the resource (e.g., MAS(s)) reserved for this peer-to-peer connection. It should be further noted that according to embodiments of the present invention, a device may, instead of transmitting a query, receive a query asking whether it has received a beacon from the coordinator device.

As indicated by a step 512, the device may or may not receive a response to this query. If no response is received, then operation proceeds to a step 514. In this step, the device commences a scanning operation to locate other devices (such as the remote device). This scanning may commence after a predetermined amount of time elapses. For instance, in the context of IEEE 802.15.3 networks, step 514 may be performed after a certain number of superframe durations have passed.

However, if a query response is received from the remote device, then in a step 516, the device determines from the response whether the remote device has received a beacon from the coordinator device. If so, then operation proceeds to step 508. As indicated above, in step 508, the device continues using the allocated reservation for direct communication with the remote device.

The device may receive a response to the query indicating that the remote device has received a beacon. Such a response may also include the contents of the received beacon. As shown in FIG. 5, if such a response is received, then operation proceeds to step 508. As indicated above, in step 508, the device continues using the allocated reservation.

Alternatively, the device may receive a response to the query indicating that the remote device has not received a beacon. If such a response is received, then a step 518 is performed. In step 518, the device waits to receive a beacon for a predetermined amount of time, such as a predetermined number of superframes.

As indicated by a step 520, if the device receives a beacon within this predetermined amount of time, then operation proceeds to step 508 in which the device continues using the reservation. However, if a beacon is not received during this predetermined amount of time, then a step 522 is performed. In step 522, the device and the remote device continue direct communications using the same timing (i.e., the same time slots of the superframe) that was allocated to the devices by the coordinator device in the superframe reservation of the extinct network (e.g., piconet).

In a step 523, the device and the remote device determine which of them will become the coordinator device of a new network (e.g., piconet). Accordingly, this step may comprise the two devices negotiating to select which device will become this coordinator.

Such determination or negotiation may be based on various rules or factors, such as device parameters. Examples of such parameters may include, for example, one or more of remaining battery power, device orientation including the number of devices a device can hear, device ID, and the like.

If the negotiation indicates that the device should become a new coordinator device, the device becomes the new coordinator device (e.g., PNC) in a step 524. Thereafter, the device (as a new coordinator device) renews the direct connection reservation with the remote device. In addition, while renewing this connection, the device may perform a scanning operation to ensure that any other coordinator devices within its coverage area are detected.

V. Query and Response Mechanisms

Aspects of the present invention involve the transmission of queries and responses. Examples of these queries are described above with reference to steps 510 and 512. Such queries and responses may be embedded in existing frame formats, or in new fields. Also, new messages may be defined to handle these queries and responses.

In embodiments of the present invention, the direct or peer-to-peer type of connection may be configured for data transfer that is predominately unidirectional. Such transfers may include, for example, downloads, file transfers, and/or server responses to client requests. For such transfers, the majority of data packets may be transmitted by one peer device, while the other device transmits smaller acknowledgment packets to signal the successful (or unsuccessful) reception of previously transmitted data packets. In embodiments of the present invention, queries and responses may be transmitted in data packets and acknowledgment packets.

VI. Recovery Scenarios

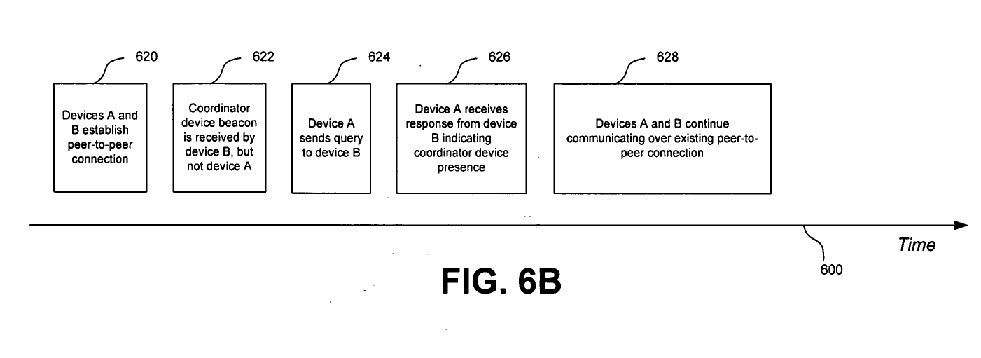

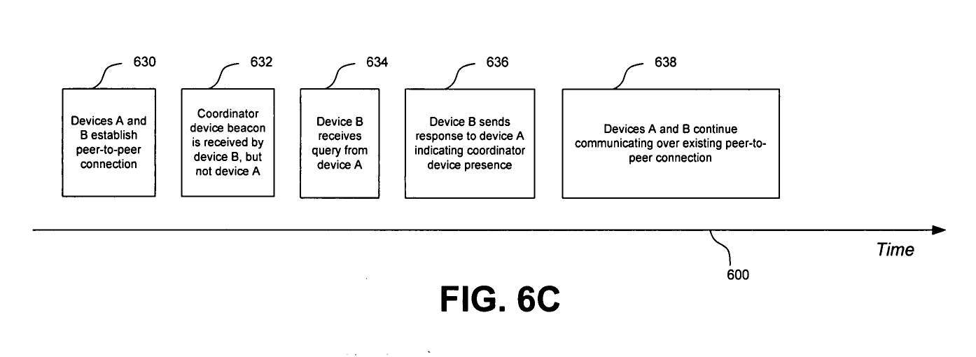

FIGS. 6A-6C are diagrams of exemplary recovery scenarios, according to embodiments of the present invention. In particular, FIGS. 6A-6C show sequences of events along a time axis 600. These scenarios involve a network that includes two devices (device A and device B) and a coordinator device. Accordingly, these scenarios may occur in the environment of FIG. 1 as well as in other environments.

Each of the depicted recovery scenarios involves a different type of coordinator device disappearance. For instance, FIG. 6A involves a total disappearance. As shown in FIG. 6A, a step 602 occurs in which devices A and B establish a peer-to-peer connection. This establishment may involve various resource allocation processes handled by the coordinator device. Subsequent to this, a step 604 occurs in which neither device A nor device B receives a beacon transmission from the coordinator device. As a result of this, device A queries device B whether it received a beacon from the coordinator device, as shown by step 606. It should be further noted that, according to embodiments of the present invention, device B may alternatively be the party sending the query. Following this, in a step 608, device A receives a response from device B (or vice versa). This response indicates device B's failure to receive a beacon from the coordinator device.

At this point, devices A and B understand that the coordinator device has disappeared from their mutual perspective. Despite this, in a step 610, devices A and B continue to use the previous channel allocation for direct peer-to-peer communication. However, to provide a complete network, the devices need to negotiate which of the devices should become a new network (e.g., piconet) coordinator. According to an exemplary embodiment, device A becomes the coordinator device in a step 612 after a negotiation indicated that device A should become the new coordinator. This step may be performed after the occurrence of a predetermined time interval in which a beacon is not received from the missing coordinator device.

FIGS. 6B and 6C involve embodiments of the present invention in which only one device of a peer-to-peer connection loses contact with the coordinator device. For instance, in FIG. 6B, devices A and B establish a peer-to-peer connection in a step 620. In a step 622, the coordinator device beacon is received by device B, but not by device A. Following step 622, device A queries device B whether it received a beacon from the coordinator device in a step 624. Device A receives a response to the query in a step 626. This response indicates that device B received the beacon from the coordinator device. In addition, the response may include information (such as parameters relating to the allocation of the peer-to-peer connection) that were contained in the beacon.

Upon receipt of this response, device A has indirectly received information regarding the coordinator device's beacon from device B. Thus, in a step 628, devices A and B may continue to use the allocated reservation for the peer-to-peer connection without one of these devices becoming a new coordinator device of a newly established piconet.

In FIG. 6C, devices A and B establish a peer-to-peer connection in a step 630. However, in a step 632, the coordinator device beacon is received by device B, but not by device A. Thus, in a step 634, device B receives a query from device A that asks whether device A receives the coordinator device's beacon. In a step 636, device B sends device A a response to this query indicating that it received this beacon. This response may include information (such as parameters of the peer-to-peer connection) that were contained in the beacon. Thus, in a step 628, devices A and B may continue to use the allocated reservation for the peer-to-peer connection without one of these devices becoming a coordinator device of a newly established piconet.

Referring again to FIG. 1, network 100 includes a coordinator device 104. Also, this network includes two direct or peer-to-peer type connections across links 122a and 122b. As described above, the term “peer-to-peer” indicates a direct, single-hop connection between two devices in a wireless ad-hoc network including a coordinator device, wherein neither of the devices participating in the connection is the coordinator device. FIG. 3 shows a situation in which coordinator device 104 totally disappears from the perspective of the these peer-to-peer connections. According to aspects of the present invention, these links are maintained through recovery techniques in which a device for each of these links becomes a new coordinator device.

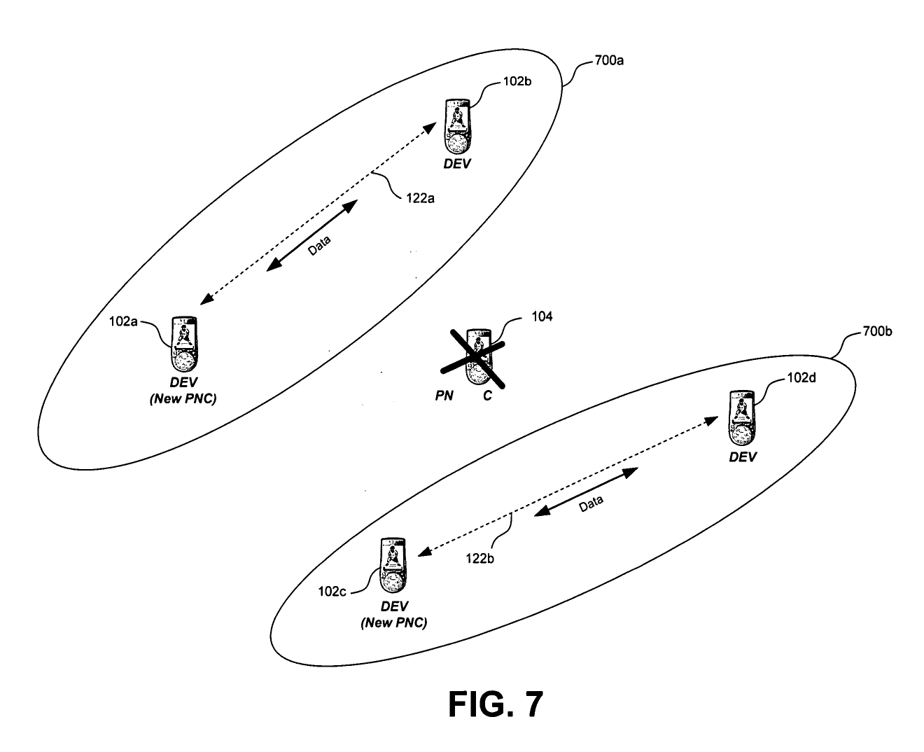

As described above, a device in a peer-to-peer connection may become a new coordinator device when, for instance, the existing coordinator device disappears from the perspective of each of the peer devices. For instance, FIG. 7 shows such a recovery, according to an embodiment of the present invention. In this recovery, device 102a becomes a coordinator device for a new network 700a, which includes devices 102a and 102b. Also, FIG. 7 shows device 102c becoming a coordinator device for a new network 700b, which includes devices 102c and 102d.

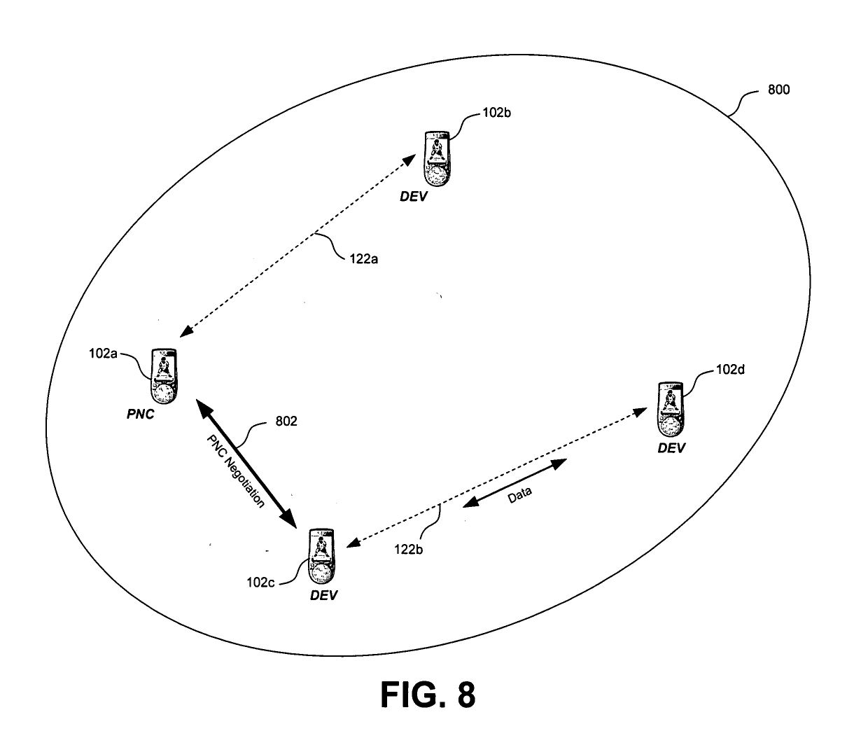

Once devices 102a and 102c have become coordinator devices, two networks exist. However, these networks may merge into a single wireless network. FIG. 8 provides an example of such a merger. In this example, networks 700a and 700b have merged into a single network 800. This merger occurred by devices 102a and 102c (i.e., the coordinator devices for networks 700a and 700b, respectively) engaging in a coordinator negotiation 802.

This negotiation involves the exchange of information between these devices and results in one of the devices taking on the coordinator device role. For instance, these devices may determine which one should be the coordinator device based on their operating characteristics, such as their remaining battery power or power source. As shown in FIG. 8, device 102a has assumed this role. From this merger, network 800 is formed, which is similar in scope to network 100 of FIG. 1.

VII. Wireless Communications Device

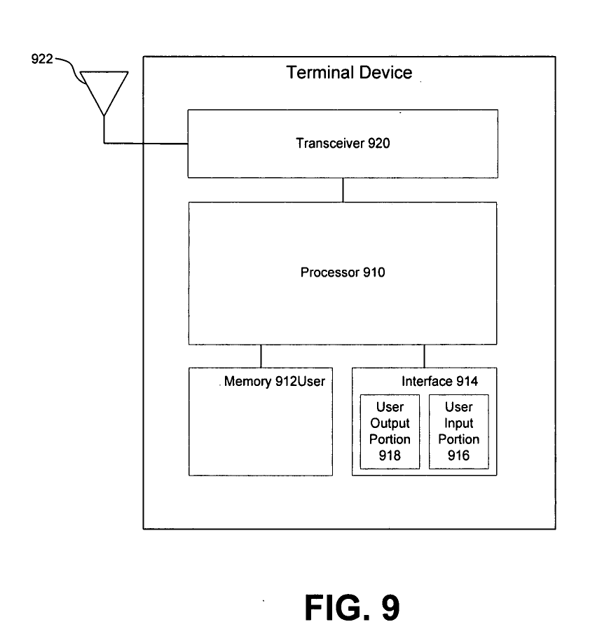

As described above, wireless communications devices, such as DEVs 102, may employ the techniques of the present invention. Accordingly, such devices may be implemented in hardware, software, firmware, or any combination thereof. One such implementation is shown in FIG. 9. This implementation includes a processor (controller) 910, a memory 912, and a user interface 914. In addition, the implementation of FIG. 9 includes a transceiver 920 and an antenna 922.

As shown in FIG. 9, transceiver 920 is coupled to antenna 922. Transceiver 920 includes electronics, which allow the device (in conjunction with antenna 922) to exchange wireless signals remote devices, such as other DEVs 102. Accordingly, transceiver 920 may include a transmitter and a receiver. In embodiments, transceiver may handle the exchange of ultra wideband (UWB) signals. For the transmission of UWB signals, such electronics may include modulation components (e.g., OFDM modulators) and/or a pulse generator for certain types of impulse UWB transmissions. For the reception of UWB signals, such electronics may include demodulation components (e.g., OFDM demodulators), timing circuitry, and filters.

As shown in FIG. 9, processor 910 is coupled to transceiver 920. Processor 910 controls device operation. Processor 910 may be implemented with one or more microprocessors that are each capable of executing software instructions (program code) stored in memory 912.

Memory 912 is a computer readable medium that may include random access memory (RAM), read only memory (ROM), and/or flash memory, and stores information in the form of data and software components (also referred to herein as modules). These software components include instructions (e.g., logic) that can be executed by processor 910. Various types of software components may be stored in memory 912. For instance, memory 912 may store software components that control the operations of transceiver 920. Also, memory 912 may store software components that provide for the functionality of a media access controller (MAC). This controller may perform various features, such as the steps described with reference to FIG. 3. It is important to note that the MAC may be implemented in hardware, software, firmware, or any combination thereof.

In addition, memory 912 may store software components that control the exchange of information through user interface 914. As shown in FIG. 9, user interface 914 is also coupled to processor 910. User interface 914 facilitates the exchange of information with a user. FIG. 9 shows that user interface 914 includes a user input portion 916 and a user output portion 918. User input portion 916 may include one or more devices that allow a user to input information. Examples of such devices include keypads, touch screens, and microphones. User output portion 918 allows a user to receive information from the wireless communications device. Thus, user output portion 918 may include various devices, such as a display, and one or more audio speakers. Exemplary displays include liquid crystal displays (LCDs), and video displays.

The elements shown in FIG. 9 may be coupled according to various techniques. One such technique involves coupling transceiver 920, processor 910, memory 912, and user interface 914 through one or more bus interfaces. In addition, each of these components is coupled to a power source, such as a rechargeable and/or removable battery pack (not shown).

VIII. Distributed Control Networks

The above description has been made with reference to networks having a central coordinator device. However, techniques of the present invention may also be applied in networks that do not employ a central coordinator. An example of such a network is defined by the Multiband OFDM Alliance (MBOA).

MBOA involves the development of a high rate physical layer (PHY) standard for the IEEE 802.15.3a WPAN. In particular, this PHY involves a frequency hopping application of orthogonal frequency division multiplexing (OFDM). In addition, the MBOA is focused on developing a Medium Access Control (MAC) layer that would be used with the OFDM physical. A current version of the MBOA MAC involves a group of wireless communications devices (referred to as a beaconing group) capable of communicating with each other. The timing employed by beaconing groups is based on a repeating pattern of superframes in which the devices may be allocated communications resources.

The MBOA MAC layer provides for the allocation of resources through beacon transmissions. Each device in a beaconing group is assigned a portion of bandwidth to transmit beacons. However, instead of having a central coordinator, the MBOA MAC provides a distributed control approach. According to this approach, multiple devices share MAC layer responsibilities, such as various channel access mechanisms that allow devices to allocate portions of the transmission medium for communications traffic. These mechanisms include a protocol called the distributed reservation protocol (DRP), and a protocol called prioritized contention access (PCA). Thus in these networks, the existence of a beacon period (BP), but not a coordinator, is needed,

In certain situations, the MBOA beacon period can become corrupted due to interference in the corresponding time period. When this occurs, beacons from other devices may not be received. Moreover, techniques of the present invention, such as the operation of FIG. 5, may be employed.

For instance, in an exemplary embodiment, a device and a remote device have a peer-to-peer connection in a network that does not have a central controller (e.g., an MBOA network). Accordingly, if the device does not receive any beacons from other devices in the network (e.g., in its beaconing group), then (as in step 510) the device may send an inquiry to the remote device.

If the remote device replies affirmatively that it received beacons from the other devices in the beaconing group, then (as indicated by steps 516 and 508) the device may safely use its preexisting allocation. In this case, the device has been assured that no collision will occur with members of its beaconing group or with devices in neighboring beaconing groups.

Conversely, if the remote device indicates that it does not hear any beacons either, the devices may continue to use the preexisting allocation (as in step 522). However, since in this case, collisions may still occur, the devices keep searching for beacons from devices within their own beaconing group (as in step 520). In embodiments, this may involve enlarging the beacon period size and/or performing scanning operations on a more frequent basis (increasing scanning). After some time, they may assume all other devices have disappeared, and turn in normal operation mode, i.e., with minimal BP size and normal scanning (as in step 524).

Thus, according to aspects of the present invention a device may participate in a wireless communications network that allocates communications resources according to a distributed approach involving beacons from the network's devices. In such networks, the device establishes a peer-to-peer connection with a remote device. This peer-to-peer connection is based on a reservation having one or more timing parameters. Upon detection of a disappearance of the network devices, the device continues to communicate with the remote device according to the one or more timing parameters of the peer-to-peer connection.

This detection of the disappearance may include a failure to receive beacon transmissions from devices in the network. For example, this may involve a failure to receive beacons from all of the devices, or from some (e.g., at least a predetermined number) of the devices in the wireless communications network. The device may send a query to the remote device regarding this disappearance. In response, the remote device may indicate that it has received the beacons (and include information from these beacons). Alternatively, the remote device may indicate that it also detected the disappearance. If so, then (as described above) the devices may search for the other devices by performing, for example, scanning operations.

Devices performing in such aspects may be implemented in the manner described above with reference to FIG. 9.

IX. Conclusion

While various embodiments of the present invention have been described above, it should be understood that they have been presented by way of example only, and not in limitation. Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents. For instance, the wireless networks described herein are provided as examples. Thus, other network types are within the scope of the present invention.

What is claimed is:

1. A method, comprising:
(a) participating in a wireless communications network, the wireless communications network having a coordinator device, the coordinator device responsible for allocating resources in the wireless communications network;
(b) establishing a peer-to-peer connection with a remote device in the wireless communications network, the peer-to-peer connection based on a reservation from the coordinator device of resources in the wireless communications network, wherein the reservation of resources has one or more timing parameters;
(c) detecting a disappearance of the coordinator device from the wireless communications network; and
(d) after the disappearance of the coordinator device is detected, communicating with the remote device according to the one or more timing parameters of the peer-to-peer connection.

2. The method of claim 1, wherein step (c) comprises failing to receive a beacon transmission from the coordinator device.

3. The method of claim 1, wherein step (c) comprises failing to receive a predetermined number of consecutive beacon transmission from the coordinator device.

4. The method of claim 1, wherein the wireless communications network employs a repeating time interval within a transmission medium, wherein the repeating time interval includes a beacon period designated for beacon transmissions.

5. The method of claim 1, further comprising:
sending a query to the remote device across the peer-to-peer connection, the query asking the remote device whether it detects the disappearance of the coordinator device from the wireless communications network.

6. The method of claim 5, wherein the query is included in a data packet.

7. The method of claim 5, wherein the query is included in an acknowledgment packet.

8. The method of claim 5, further comprising:
receiving a response to the query from the remote device, the response indicating that the remote device has detected the disappearance of the coordinator device from the wireless communications network.

9. The method of claim 8, further comprising:
after receipt of the response from the remote device, waiting for a reappearance of the coordinator device during a predetermined time interval; and
if the remote device indicates that it has also detected the disappearance of the coordinator device from the wireless communications network, determining with the remote device whether to become a new coordinator device for the wireless communications network when the coordinator device fails to reappear during the predetermined time interval.

10. The method of claim 9, wherein the determining step includes negotiating with the remote device.

11. The method of claim 10, wherein the negotiating step includes exchanging terminal parameters with the remote device.

12. The method of claim 5, further comprising:
receiving a response to the query from the remote device, the response indicating that the remote device continues to detect the presence of the coordinator device in the wireless communications network.

13. The method of claim 12, wherein the response includes parameters of the peer-to-peer connection with the remote device.

14. The method of claim 12, wherein the response is included in at least one of a data packet and an acknowledgment packet.

15. The method of claim 1, wherein the wireless communications network is an IEEE 802.15.3 network.

16. An apparatus, comprising:
means for participating in a wireless communications network, the wireless communications network having a coordinator device, the coordinator device responsible for allocating resources in the wireless communications network;
means for establishing a peer-to-peer connection with a remote device in the wireless communications network, the peer-to-peer connection based on a reservation from the coordinator device of resources in the wireless communications network, wherein the reservation of resources has one or more timing parameters;
means for detecting a disappearance of the coordinator device from the wireless communications network; and
means for, after the disappearance of the coordinator device is detected, communicating with the remote device according to the one or more timing parameters of the peer-to-peer connection,

17. The apparatus of claim 16, further comprising:
means for sending a query to the remote device across the peer-to-peer connection, the query asking the remote device whether it detects the disappearance of the coordinator device from the wireless communications network.

18. The apparatus of claim 17, further comprising:
means for receiving a response to the query from the remote device, the response indicating that the remote device has detected the disappearance of the coordinator device from the wireless communications network.

19. An apparatus, comprising:
a transceiver configured to exchange wireless signals with a remote device in a peer-to-peer connection of a wireless communications network, the wireless communications network having a coordinator device responsible for allocating resources in the wireless communications network, wherein the peer-to-peer connection is based on a reservation of resources received from the coordinator device, the reservation of resources having one or more timing parameters; and
a controller configured to detect a disappearance of the coordinator device from the wireless communications network;
wherein the transceiver is further configured to communicate with the remote device according to the one or more timing parameters of the peer-to-peer connection after the disappearance of the coordinator device is detected,

20. The apparatus of claim 19, wherein the transceiver is further configured to receive an indication that the remote device has also detected the disappearance of the coordinator device; and
wherein, based on the indication, the controller is further configured to cause the apparatus to determine with the remote device whether to become a new coordinator device for the wireless communications network when the coordinator device fails to reappear during a predetermined time interval.

21. The apparatus of claim 20, wherein the wireless communications network employs a repeating time interval within a transmission medium, wherein the repeating time interval includes a beacon slot designated for beacon transmissions.

22. The apparatus of claim 19, wherein the wireless communications network is an IEEE 802.15.3 network.

23. A computer program product comprising a computer useable medium having computer program logic recorded thereon for enabling a processor in a communications device, the computer program logic comprising:
program code for enabling the processor to cause the device to participate in a wireless communications network, the wireless communications network having a coordinator device, the coordinator device responsible for allocating resources in the wireless communications network;
program code for enabling the processor to cause the device to establish a peer-to-peer connection with a remote device in the wireless communications network, the peer-to-peer connection based on a reservation from the coordinator device of resources in the wireless communications network, wherein the reservation of resources has one or more timing parameters;
program code for enabling the processor to detect a disappearance of the coordinator device from the wireless communications network; and
program code for enabling the processor to cause the device to, after the disappearance of the coordinator device is detected, communicate with the remote device according to the one or more timing parameters of the peer-to-peer connection.

24. A system, comprising:
a coordinator device responsible for allocating resources in a wireless communications network; and
first and second wireless communications devices having a peer-to-peer connection with a remote device in the wireless communications network, the peer-to-peer connection based on a reservation from the coordinator device of resources in the wireless communications network, wherein the reservation of resources has one or more timing parameters;
wherein the first and second wireless communications devices are configured to communicate with the remote device according to the one or more timing parameters of the peer-to-peer connection after a disappearance of the coordinator device is detected.

25. A method, comprising:
(a) participating in a wireless communications network having a plurality of devices, the wireless communications network configured to allocate communications resources according to a distributed approach, wherein the distributed approach involves the transmission of beacons from each of the plurality of devices using allocated beacon slots;
(b) establishing a peer-to-peer connection with a remote device in the wireless communications network, the peer-to-peer connection based on a reservation having one or more timing parameters;
(c) detecting a disappearance of the plurality of devices from the wireless communications network; and
(d) after the disappearance is detected, communicating with the remote device according to the one or more timing parameters of the peer-to-peer connection.

26. The method of claim 25, wherein step (c) comprises:
failing to receive beacon transmissions from the plurality of devices.

27. The method of claim 25, further comprising:
receiving a communication from the remote device, and
if the communication comprises an indication that the remote device has also detected the disappearance:
communicating with the remote device according to the one or more timing parameters of the peer-to-peer connection to maintain the peer-to-peer connection with the remote device,
transmitting a beacon using one of the allocated beacon slots of the wireless communications network, and
increasing scanning for beacons from the plurality of devices.

28. The method of claim 25, further comprising:
receiving a communication from the remote device; and
if the communication comprises an indication that the remote device has not detected the disappearance:
maintaining the peer-to-peer connection with remote device, and
transmitting beacons using one of the allocated beacon slots to maintain participation in the wireless communications network.

29. An apparatus, comprising:
a transceiver configured to exchange wireless signals with a remote device in a peer-to-peer connection of a wireless communications network having a plurality of devices, the wireless communications network configured to allocate communications resources according to a distributed approach, wherein the distributed approach involves the transmission of beacons from each of the plurality of devices using allocated beacon slots; and
a controller configured to detect a disappearance of the plurality of devices from the wireless communications network;
wherein the transceiver is further configured to communicate with the remote device according to the one or more timing parameters of the peer-to-peer connection after the disappearance is detected,

30. A computer program product comprising a computer useable medium having computer program logic recorded thereon for enabling a processor in a communications device, the computer program logic comprising:
program code for enabling the processor to cause the device to participate in a wireless communications network having a plurality of devices, the wireless communications network configured to allocate communications resources according to a distributed approach, wherein the distributed approach involves the transmission of beacons from each of the plurality of devices using allocated beacon slots;
program code for enabling the processor to cause the device to establish a peer-to-peer connection with a remote device in the wireless communications network, the peer-to-peer connection based on a reservation having one or more timing parameters;
program code for enabling the processor to detect a disappearance of the plurality of devices from the wireless communications network; and
program code for enabling the processor to cause the device to, after the disappearance is detected, communicate with the remote device according to the one or more timing parameters of the peer-to-peer connection.
